(19) United States
(12) Patent Application Publication
(10) Pub. No.: US 2016/0313509 A1
(43) Pub. Date: Oct. 27, 2016

(54) METHOD OF MANUFACTURING WAVELENGTH MULITPLEXING OPTICAL COMMUNICATION MODULE

(71) Applicant: Mitsubishi Electric Corporation, Tokyo (JP)

(72) Inventors: Nobuo OHATA, Tokyo (JP); Tadayoshi HATA, Tokyo (JP); Yoshiyuki KAMO, Tokyo (JP); Akihiro MATSUSUE, Tokyo (JP); Koichi NAKAMURA, Tokyo (JP)

(73) Assignee: Mitsubishi Electric Corporation, Tokyo (JP)

(21) Appl. No.: 15/000,706

(22) Filed: Jan. 19, 2016

(30) Foreign Application Priority Data
Apr. 23, 2015 (JP) 2015-088346

(51) Int. Cl. G02B 6/293; B29C 59/02; B29D 11/00; G02B 6/42; B29C 65/00

(52) U.S. Cl. CPC G02B 6/2938; G02B 6/4249; G02B 6/4204; B29C 66/004; B29D 11/0075; B29C 59/022; B29C 66/733; B29L 2011/0075

(57) ABSTRACT

A method of manufacturing a wavelength multiplexing optical communication module which includes a plurality of light emitting elements, a plurality of optical lenses adjusting wavefronts of emergent lights from the plurality of light emitting elements, and a multiplexer combining the lights adjusted by the plurality of optical lenses, includes: applying a resin on a carrier so as to have a shape with a curvature symmetric about a rotation axis; and bonding a lower surface of the optical lens to the carrier with the resin, wherein a recess having a curvature is formed at a center of the lower surface of the optical lens.

### BACKGROUND OF THE INVENTION

1. Field of the Invention

The present invention relates to a method of manufacturing a wavelength multiplexing optical communication module.

2. Background Art

There is a demand for providing an optical communication module capable of transmitting and receiving a large-capacity signal to cope with the increase in traffic in recent years. A plurality of waves are multiplexed in an optical communication module, thereby realizing large-capacity communication. In a conventional wavelength multiplexing optical communication module, an optical lens, which is an optical component for optical coupling, is disposed in front of each of light emitting elements and is fixed with a resin, and cut portions of the optical lens are formed at ends of a bonding surface for the purpose of limiting interference of the resin between the optical lenses (see, for example, Japanese Patent Laid-Open No. 2014-85639). Providing grooves in a bonding surface for the purpose of maintaining position accuracy in mounting an optical lens with solder has also been proposed (see, for example, Japanese Patent Laid-Open Nos. 2013-080900, 2002-107594, 63-56922, and 2006-251212).

Conventionally, the optical lens has a flat bonding surface. There is, therefore, a problem that when the optical lens is mounted at a position shifted from the position of the resin applied, the resin asymmetrically attaches to the lens and stress is asymmetrically generated in a direction parallel to or perpendicular to the optical axis at the time of curing of the resin to shift the position of the optical lens from the desired position. Also, in mounting the optical lens with solder, the effect of limiting the amount of misalignment of the position of the optical lens cannot be sufficiently exerted even if grooves are provided in the bonding surface, because the controllability of the shape of solder in the applied state is low.

### SUMMARY OF THE INVENTION

In view of the above-described problem, an object of the present invention is to provide a method of manufacturing a wavelength multiplexing optical communication module capable of limiting the amount of misalignment of the position of an optical lens even when the position of a resin applied is shifted from a center of the optical lens.

According to the present invention, a method of manufacturing a wavelength multiplexing optical communication module which includes a plurality of light emitting elements, a plurality of optical lenses adjusting wavefronts of emergent lights from the plurality of light emitting elements, and a multiplexer combining the lights adjusted by the plurality of optical lenses, includes: applying a resin on a carrier so as to have a shape with a curvature symmetric about a rotation axis; and bonding a lower surface of the optical lens to the carrier with the resin, wherein a recess having a curvature is formed at a center of the lower surface of the optical lens.

In the present invention, the resin is applied on the carrier so as to have a shape with a curvature symmetric about a rotation axis and a recess having a curvature is formed at a center of the lower surface of the optical lens. Therefore, the amount of misalignment of the position of an optical lens can be limited even when the position of a resin applied is shifted from a center of the optical lens.

Other and further objects, features and advantages of the invention will appear more fully from the following description.

### BRIEF DESCRIPTION OF THE DRAWINGS

FIG. 1 is a perspective view of a wavelength multiplexing optical communication module according to a first embodiment of the present invention.

FIGS. 2, 3, and 4 are a side view, a sectional view and a bottom view, respectively, of the optical lens according to the first embodiment of the present invention.

FIG. 5 is a sectional view showing a state where the optical lens according to the first embodiment of the present invention is mounted on the carrier.

FIG. 6 is a plan view for a method of manufacturing the wavelength multiplexing optical communication module according to the first embodiment of the present invention.

FIGS. 7 and 8 are sectional views for a method of manufacturing the wavelength multiplexing optical communication module according to the first embodiment of the present invention.

FIGS. 9 and 10 are sectional views for a method of manufacturing a wavelength multiplexing optical communication module according to a comparative example.

FIGS. 11 and 12 are a side view and a bottom view, respectively, of an optical lens according to a second embodiment of the present invention.

FIG. 13 is a sectional view of an optical lens according to a third embodiment of the present invention.

### DETAILED DESCRIPTION OF THE PREFERRED EMBODIMENTS

A method of manufacturing a wavelength multiplexing optical communication module according to the embodiments of the present invention will be described with reference to the drawings. The same components will be denoted by the same symbols, and the repeated description thereof may be omitted.

### First Embodiment

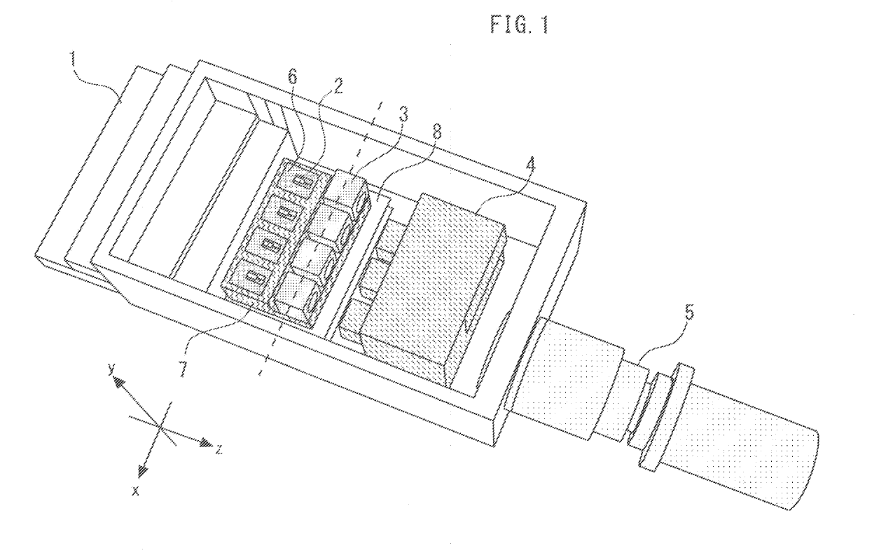

FIG. 1 is a perspective view of a wavelength multiplexing optical communication module according to a first embodiment of the present invention. A plurality of light emitting elements 2 which oscillate different wavelengths of light are provided in a package 1 of the wavelength multiplexing optical communication module. A plurality of optical lenses 3 convert emergent lights from the plurality of light emitting elements 2 into collimated light by adjusting the wavefronts of the emergent lights. A multiplexer 4 combines the lights adjusted by the plurality of optical lenses 3. This combined light is imaged on a waveguide in a receptacle 5 externally attached to the package by one lens attached in a stage in front of the receptacle 5.

The light emitting elements 2 are mounted on a radiofrequency substrate 6 which is bonded on a carrier 7. A Peltier element 8 for temperature adjustment is disposed on lower surfaces of the light emitting elements 2. The radiofrequency substrate 6 and the Peltier element 8 are electrically connected to a feed-through part of the package 1 by gold wires or the like.

Relative misalignments between emission points on the light emitting elements 2 and the positions of centers of the optical lenses 3 cause variations in the angles of emergence of light from the optical lenses 3 and lead to positional variations of the imaging point on the receptacle 5, resulting in a reduction in the efficiency of coupling to the receptacle 5. Therefore, the positions of the optical lenses 3 are actively adjusted in x-, y- and z-directions so that the points of emission of light from the light emitting elements 2 and the positions of the centers of the optical lenses 3 coincide with each other, and the optical lenses 3 are bonded and fixed on the carrier 7 with a resin 9.

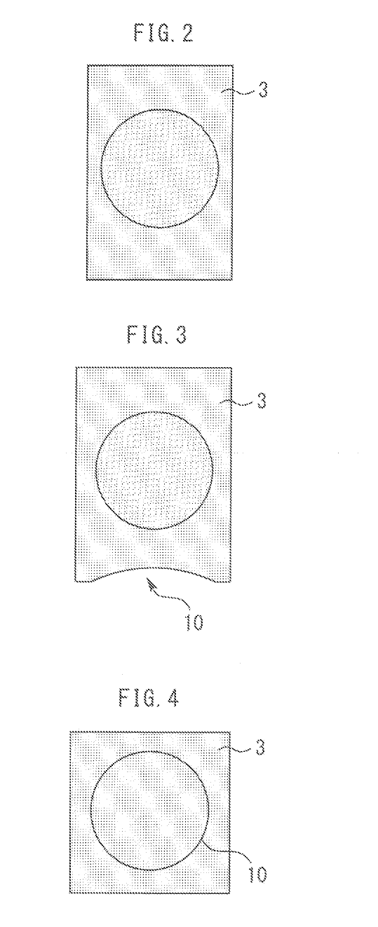

FIGS. 2, 3, and 4 are a side view, a sectional view and a bottom view, respectively, of the optical lens according to the first embodiment of the present invention. A recess 10 having a curvature is formed in a lower surface of the optical lens 3 at a center of the lower surface.

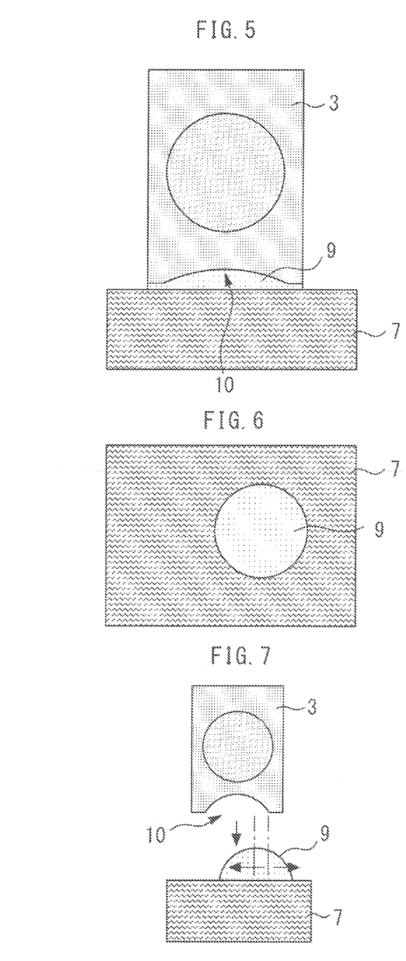

FIG. 5 is a sectional view showing a state where the optical lens according to the first embodiment of the present invention is mounted on the carrier. The lower surface of the optical lens 3 in which the recess 10 is formed and the flat carrier 7 are bonded to each other with the resin 9.

A method of manufacturing the wavelength multiplexing optical communication module according to the present embodiment will subsequently be described. FIG. 6 is a plan view for a method of manufacturing the wavelength multiplexing optical communication module according to the first embodiment of the present invention. FIGS. 7 and 8 are sectional views for a method of manufacturing the wavelength multiplexing optical communication module according to the first embodiment of the present invention.

First, as shown in FIG. 6, the resin 9 is applied on the carrier 7 so as to have a shape with a curvature symmetric about a rotation axis. Next, the optical lens 3 is pressed on the resin 9, as shown in FIG. 7. At this time, the position of a center of the resin 9 applied on the carrier 7 is set inside an end portion of the recess 10 of the optical lens 3. The resin 9 is thereafter cured, thus bonding the lower surface of the optical lens 3 to the carrier 7 with the resin 9, as shown in FIG. 8.

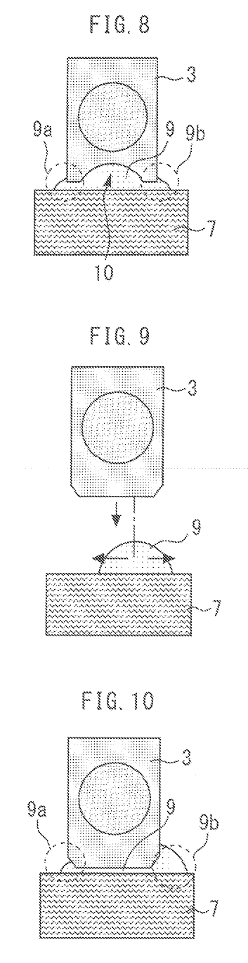

The advantages of the present embodiment will be described while being compared with a comparative example. FIGS. 9 and 10 are sectional views for a method of manufacturing a wavelength multiplexing optical communication module according to a comparative example. In the comparative example, the lower surface of the optical lens 3, which is a bonding surface, is flat. When the optical lens 3 is pressed on the resin 9 while these two members are positioned relative to each other in a case where the position of the resin 9 applied is misaligned from the center of the optical lens 3 as shown in FIG. 9, bulging-out portions 9a and 9b of the resin 9 bulging out from the optical lens 3 in opposite directions are asymmetrical, as shown in FIG. 10. Therefore, stress is caused when the resin 9 is cured. The optical lens 3 is thereby moved laterally, so that the optical lens 3 center position is shifted with respect to the point of emission of light from the light emitting element 2. As a result, the point of imaging on the receptacle 5 is shifted and the coupling efficiency is reduced.

In the present embodiment, the recess 10 having a curvature is formed in the lower surface of the optical lens 3. Therefore, even if the position of the resin 9 applied is misaligned from the center of the optical lens 3 as shown in FIG. 7, the degree of asymmetry of the bulging-out portion 9a and the bulging-out portion 9b of the resin 9 is reduced as shown in FIG. 8, because the resin 9 moves along the recess 10 of the optical lens 3 when the optical lens 3 is pressed on the resin 9. The amount of misalignment of the position of the optical lens 3 at the time of curing of the resin 9 can thereby be reduced. Consequently, the reduction in the efficiency of coupling to the receptacle 5 can be reduced. The interference of the resin 9 with the adjacent optical lenses 3 can also be limited because the amount of bulging-out of the resin 9 is also reduced. Also, the bonding strength is improved because the bonding surface area is increased.

Not solder but the resin 9 is used as an adhesive, thereby enabling optical axis alignment at a low temperature in comparison with the case of using solder and avoiding being easily influenced by thermal linear expansion. Also, the resin 9 has high controllability with respect to the shape at the time of application in comparison with solder. Therefore, the resin 9 can be applied on the carrier 7 so as to have a shape with a curvature symmetric about a rotation axis. The above-described effect of limiting the amount of misalignment of the position of the optical lens 3 can thus be exerted sufficiently.

When the optical lens 3 is pressed on the resin 9, the position of the center of the resin 9 applied on the carrier 7 is set inside an end portion of the recess 10 of the optical lens 3. Control of the amount of relative position misalignment in this way ensures that the degree of asymmetry of the resin bulging-out portions can be effectively reduced.

It is preferable that the shape of the recess 10 correspond to the shape of the resin 9 applied on the carrier 7. If this correspondence is ensured, the misalignment of the position of the optical lens 3 can be limited more effectively. The amount of bulging-out of the resin 9 can also be reduced.

### Second Embodiment

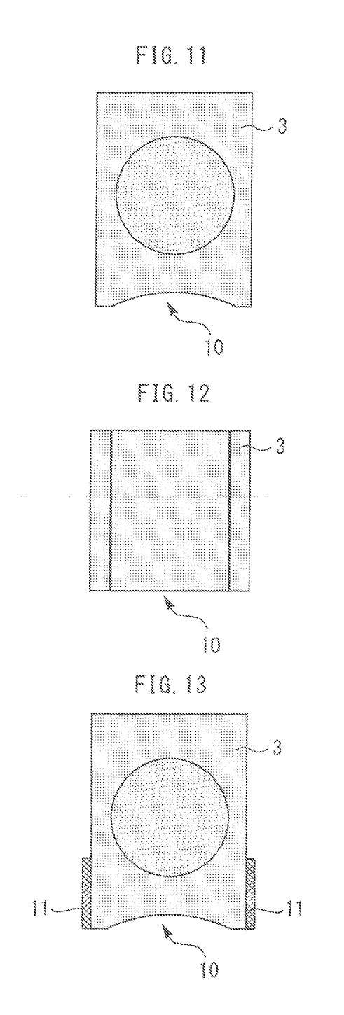

FIGS. 11 and 12 are a side view and a bottom view, respectively, of an optical lens according to a second embodiment of the present invention. In the present embodiment, the shape of the recess 10 is a semicylindrical shape extending through the optical lens 3 between opposite side surfaces of the optical lens 3. Therefore, air can escape easily when the optical lens 3 is pressed on the resin 9, and air cannot easily be confined between the optical lens 3 and the resin 9. As a result, degradation in bonding strength and separation of the resin under a varying temperature condition due to confinement of air can be reduced. Also, the bonding strength can be improved because the bonding surface area is increased.

### Third Embodiment

FIG. 13 is a sectional view of an optical lens according to a third embodiment of the present invention. In the present embodiment, an attachment preventive film 11 formed of a material less wettable to the resin 9 than the material of the optical lens 3 is formed on side surfaces of the optical lens 3 before the optical lens 3 is bonded to the carrier 7. For example, gold is deposited as attachment preventive film 11. In this way, attachment of the resin 9 bulging out to the side surfaces of the optical lens 3 can be prevented, thus limiting the amount of misalignment of the position of the optical lens 3 when the resin 9 is cured.

Obviously many modifications and variations of the present invention are possible in the light of the above teachings. It is therefore to be understood that within the scope of the appended claims the invention may be practiced otherwise than as specifically described.

The entire disclosure of Japanese Patent Application No. 2015-088346, filed on Apr. 23, 2015 including specification, claims, drawings and summary, on which the Convention priority of the present application is based, is incorporated herein by reference in its entirety.

What is claimed is:

1. A method of manufacturing a wavelength multiplexing optical communication module which includes a plurality of light emitting elements, a plurality of optical lenses adjusting wavefronts of emergent lights from the plurality of light emitting elements, and a multiplexer combining the lights adjusted by the plurality of optical lenses, comprising:
applying a resin on a carrier so as to have a shape with a curvature symmetric about a rotation axis; and
bonding a lower surface of the optical lens to the carrier with the resin,
wherein a recess having a curvature is formed at a center of the lower surface of the optical lens.

2. The method of manufacturing a wavelength multiplexing optical communication module of claim 1, wherein when the optical lens is pressed on the resin, a position of a center of the resin applied on the carrier is set inside an end portion of the recess of the optical lens.

3. The method of manufacturing a wavelength multiplexing optical communication module of claim 1, wherein a shape of the recess corresponds to a shape of the resin applied on the carrier.

4. The method of manufacturing a wavelength multiplexing optical communication module of claim 1, wherein a shape of the recess is a semicylindrical shape extending through the optical lens between opposite side surfaces of the optical lens.

5. The method of manufacturing a wavelength multiplexing optical communication module of claim 1, further comprising forming an attachment preventive film formed of a material less wettable to the resin than material of the optical lens on side surfaces of the optical lens before the optical lens is bonded to the carrier.
